(19) United States
(12) Patent Application Publication
(10) Pub. No.: US 2026/0258752 A1
(43) Pub. Date: Sep. 3, 2026

(54) SYSTEM FOR RECOVERING ENERGY

(71) Applicant: Primetals Technologies Germany GmbH, Erlangen (DE)

(72) Inventors: Thomas MATSCHULLAT, Eckental (DE); Klaus WEINZIERL, Nürnberg (DE)

(21) Appl. No.: 19/490,020

(22) PCT Filed: May 8, 2024
(86) PCT No.: PCT/EP2024/062766

§ 371 Date: Dec. 4, 2025

(30) Foreign Application Priority Data
Jun. 7, 2023 (EP) 23177959.6

(51) Int. Cl. F02C 6/10; F02C 1/06

(52) U.S. Cl. CPC F02C 6/10; F02C 1/06; F05D 2220/60; F05D 2260/221

(57) ABSTRACT

A system for recovering energy has a main plant that produces a hot exhaust gas. The main plant has a discharge device, through which the exhaust gas flows and is discharged from the main plant. The system has compressors that compress air having an initial temperature from an initial pressure to a final pressure and an intermediate temperature. The system has a heat exchanger arranged downstream of the compressors through which the air compressed to the final pressure flows, and is heated by the heat of the exhaust gas to a final temperature. The system has a compressed air motor arranged downstream of the heat exchanger that is operated with the air heated to the final temperature, and discharges the air after use at a discharge temperature and a discharge pressure.

### TECHNICAL FIELD

The present invention is based on a system for recovering energy,
wherein the system has a main plant, during the operation of which a hot waste gas is produced,
wherein the main plant has a discharge device, through which the waste gas flows and via which the waste gas is discharged from the main plant.

### PRIOR ART

Systems of this kind are generally known. Purely by way of example, reference may be made to EP 10 770 810 B1.

### SUMMARY OF THE INVENTION

Large amounts of “low-grade” thermal energy are produced in many industrial processes. These quantities of energy are often unused, or used only to a limited extent. Instead, the waste heat is simply given off to the environment or during cold times of year used—even if usually only on a small scale—for example to heat office buildings or homes. For example, in a slab reheating furnace of a rolling mill, the thermal power used is often in the order of magnitude of approximately 100 MW. It is estimated that approximately 70% of this actually flows into the slabs. The rest remains unused—at a typical waste gas temperature of approximately 300° C. In other industrial plants, for example an electric steelworks, even larger amounts of waste heat are sometimes produced.

In many industrial plants, relatively large quantities of compressed air are furthermore often required. For example, in a cooling section of a hot strip rolling mill, the valves, by means of which cooling water is applied to the rolled flat material, are often operated with compressed air. The compressed air is also used, for example, to blow off excess cooling water from the top side of the rolled flat material or to generate an air stream, which is directed away from measuring equipment so that it is not contaminated. The compressed air—both in a steelworks and in other industrial plants—is generated by means of compressors which are driven using electrical energy.

Many solutions are known from the prior art in order to recover electrical energy from the waste heat from industrial processes. However, the solutions from the prior art are usually not used in practice. In particular, the efficiency is often only very low and the costs associated with implementing these solutions have no meaningful relationship with the possible recovery of energy.

It is known to install a heat exchanger in the discharge device, the heat exchanger heating a thermal oil. The heated thermal oil is used to heat a coolant, which for its part drives a gas turbine, in a further heat exchanger. The coolant can be selected as required, depending on the temperature level of the waste gas. This solution from the prior art still appears to be the most promising. However, it is also often not used since it is not economical either. Although one advantage of this solution is that no steam circuit has to be installed, it is disadvantageous that thermal oil has to be used. However, a thermal oil will chemically decompose at temperatures above approximately 300° C. Therefore, the use of this technique is limited, in principle, to waste gases of at most approximately 300° C.

DE 10 2009 030 146 A1 discloses a system which is used to recover electrical energy. The system has a compressor arrangement, which has a number of compressors. Air is compressed to a final pressure by means of the compressor arrangement. The final pressure may lie at a relatively large value of, for example, 300 bar. The compressed air is expanded to a considerably lower intermediate pressure of typically 40 bar to 80 bar by means of a first reduction valve. The expanded air is heated to the ambient temperature by means of a heat exchanger 10 arranged downstream of the first reduction valve 9 and supplied to a buffer store. The air extracted from the buffer store is expanded to a once again considerably lower pressure by means of a second reduction valve. This pressure is the working pressure. It may lie between 5 bar and 20 bar. The once again expanded air is again heated to the ambient temperature by means of a heat exchanger arranged downstream of the second reduction valve. The air is only then heated to a higher temperature of approximately 300° C. in a heat exchanger. The thermal energy is supplied to the heat exchanger by a heat source, which may be a heat store which is fed by a solar-thermal plant. The heated air is supplied to a compressed-air motor, which can operate a generator.

The object of the present invention is to provide ways in which the recovery of energy from the waste heat from the industrial technical process, i.e. from the heat from the hot waste gas of the main plant, can be improved.

The object is achieved by a system for recovering energy having the features of claim 1. Dependent claims 2 to 15 relate to advantageous configurations of the system.

According to the invention, a system for recovering energy of the kind mentioned at the outset is configured
in that the system has a compressor arrangement having a number of compressors, by means of which air supplied to the compressor arrangement and having an initial temperature is compressed from an initial pressure to a final pressure and an intermediate temperature,
in that the system has a heat exchanger arranged downstream of the compressor arrangement, through which the air compressed to the final pressure and the intermediate temperature flows and by means of which the heat of the waste gas flowing through the discharge device is supplied to the air flowing through the heat exchanger and thus the air is heated to a final temperature, and
in that the system has a compressed-air motor which is arranged downstream of the heat exchanger, to which the air heated to the final temperature and having the final pressure is supplied, which is operated with this air and from which the air is output at an output temperature and an output pressure.

The main plant can be designed as desired, provided that it generates the hot waste gas. The main plant is often a plant used in the steel industry, in particular a slab reheating furnace, a blast furnace, a converter or electric steelworks. However, the present invention is not restricted to plants of this kind.

In general, an electrical generator, by means of which electrical energy is generated, is driven by the compressed-air motor. However, in some cases, the mechanical energy generated by the compressed-air motor can also be utilized in other ways.

With preference, the number of compressors is greater than 1 and the compressors are arranged one behind the other in series, so that the air, starting from the initial pressure, is compressed to the final pressure in several stages. In this case, the system preferably has cooling devices which are arranged between two successive compressors in each case and by means of which the air conveyed from the compressor arranged upstream of the respective cooling device to the compressor arranged downstream of the respective cooling device is cooled. As a result, the energy expenditure required to operate the compressors can be reduced, the quantity of compressed air can be maximized at the same time and furthermore the intermediate temperature can also be kept relatively low. Therefore, the heat of the hot waste gas can be used to a far better extent to heat the compressed air. At the same time, the waste gas can be cooled to a greater extent. The air in the cooling devices is generally cooled as much as possible, if possible down to the initial temperature. However, there is no cooling device arranged downstream of the last compressor, by which the air is compressed to the final pressure and the intermediate temperature. In the case of a single compressor, this applies to the single compressor.

It is possible for the system to have a further heat exchanger, which is arranged in the discharge device and by means of which the heat of the waste gas is transmitted to an intermediate medium, and for the intermediate medium to act directly or indirectly on the heat exchanger heating the air. The intermediate medium may be a thermal oil, for example. The use of the further heat exchanger is suitable particularly when the waste gas has a temperature of 300° C. or less.

In the case of the further heat exchanger and the intermediate medium being used, one advantageous configuration is that the system has a heat store, that the heat exchanger is arranged at least in the upper region of the heat store and preferably the air flowing through the heat exchanger flows through the heat store from bottom to top, and that a heat output device is arranged at least in the lower region of the heat store and preferably the intermediate medium flows through the heat store from top to bottom, so that the intermediate medium introduces heat into the heat store via the heat output device.

On account of the heat store, a certain buffer capacity can be provided in particular, so that uniform operation of the compressed-air motor can be achieved despite varying quantities of hot waste gas.

It is possible for the heat output device to simply be a feed pipe via which the intermediate medium is fed into the heat store. In this case, a portion of the intermediate medium is located in the heat store. The intermediate medium and the storage medium of the heat store are one and the same medium in this case. As an alternative, the heat output device may be a (further) heat exchanger, so that the medium of the heat store is separated from the intermediate medium.

As an alternative, it is possible for the heat exchanger to be arranged in the discharge device, so that the heat of the waste gas is transmitted directly to the heat exchanger. This solution is advantageous particularly when the waste gas has a temperature above 300° C. This is because usual intermediate media, for example a thermal oil, are often no longer stable at such temperatures.

The system preferably has a compressed-air reservoir, which is arranged between the heat exchanger and the compressed-air motor. As a result, compressed air can be generated and stored in advance—within the capacity of the compressed-air reservoir. The operation of the compressed-air motor can therefore be stabilized.

In a particularly simple configuration, the air supplied to the compressor arrangement is extracted from the surrounding area. As a result, no compressed-air reservoir is required at the input end of the compressor arrangement. Precompression of the air is not required either. However, it may be necessary to purify the air before supplying it to the compressor arrangement. Analogously, in a particularly simple configuration, the air output by the compressed-air motor is also output to the surrounding area.

The system preferably has a control device, by means of which the compressor arrangement and/or the compressed-air motor are controlled in such a way that the output temperature and the output pressure at least approximately correspond to the initial pressure and the initial temperature. As a result, the resulting efficiency of the overall arrangement can be optimized.

The compressors of the compressor arrangement can be designed as required. In some cases, it may be possible for the compressor arrangement to have gas turbines as compressors. However, other configurations are often more advantageous.

For example, the compressors can each be designed as follows:
the compressors have a first and a second shaft, the shaft axes of which are arranged parallel to each other with a lateral offset and which rotate synchronously and at the same rotation speed during operation, so that the two shafts roll on each other and are sealed off from each other in an airtight manner,
the compressors have a housing, which annularly surrounds the first shaft,
the first shaft has, on its outer side, a lug which encircles the housing in a sealing manner,
the second shaft has, on its outer side, a recess which the lug of the first shaft temporarily enters when the shafts rotate and from which the lug of the first shaft is later released again,
a supply opening and an outlet opening are arranged in the housing, the supply opening and the outlet opening being passed by the lug, as seen in the rotation direction of the first shaft, shortly after it is released from the recess or shortly before it enters the recess, so that the lug divides a respective cavity formed by the first shaft and the surrounding housing into a first and a second portion, wherein the first portion extends from the angular position at which the lug of the first shaft is released from the recess in the second shaft up to the instantaneous angular position of the lug and the second portion extends from the instantaneous position of the lug up to the angular position at which the lug of the first shaft enters the recess in the second shaft,
the inlet opening is permanently open, so that air is continuously supplied to the first portion,
the compressed air is output via the outlet opening,
a closing apparatus is assigned to the outlet opening, the outlet opening being briefly opened by the closing apparatus during a period in which the lug of the first shaft is just about to enter the recess in the second shaft, and then being closed again.

The outlet opening can be opened and closed owing to the shaping of the first and the second shaft. Provided that the outlet opening is open, the compressed air can be extracted from the respective compressor.

Such a configuration of a compressor is known per se. In particular, the compressor parts of an Astron motor are designed in this way. Astron motors are described in detail in US 2021/0 040 885 A1, U.S. Pat. No. 10,844,782 B1, US 2022/0 056 802 A1 and US 2023/0 092 617 A1.

However, it is particularly advantageous when the compressors are designed as screw compressors. Screw compressors are generally known to those skilled in the art. Purely by way of example, reference may be made to the German Wikipedia entry “Zahnradpumpe [Gear pump]” and the paragraph “Schraubenpumpe [Screw pump]”, retrieved on May 5, 2023. Screw compressors are also commercially available. A screw compressor typically has two oppositely rotating shafts which enclose air in a chamber between them. The chamber moves in the axial direction when the two shafts rotate, with the chamber volume decreasing.

The compressed-air motor can also be designed as required. For example, the compressed-air motor can be designed as a gas turbine. Similarly, the compressed-air motor can be designed as follows:
the compressed-air motor has a first and a second shaft, the shaft axes of which are arranged parallel to each other with a lateral offset and which rotate synchronously and at the same rotation speed during operation, so that the two shafts roll on each other and are sealed off from each other in an airtight manner,
the compressed-air motor has a housing, which annularly surrounds the first shaft,
the first shaft has, on its outer side, a lug which encircles the housing in a sealing manner,
the second shaft has, on its outer side, a recess which the lug of the first shaft temporarily enters when the shafts rotate and from which the lug of the first shaft is later released again,
a supply opening and an outlet opening are arranged in the housing, the supply opening and the outlet opening being passed by the lug, as seen in the rotation direction of the first shaft, shortly after it is released from the recess or shortly before it enters the recess, so that the lug divides an annular cavity formed by the first shaft and the surrounding housing into a first and a second portion, wherein the first portion extends from the angular position at which the lug of the first shaft is released from the recess in the second shaft up to the instantaneous angular position of the lug and the second portion extends from the instantaneous position of the lug up to the angular position at which the lug of the first shaft enters the recess in the second shaft,
a closing apparatus is assigned to the supply opening, the supply opening being briefly opened by the closing apparatus during a period in which the lug of the first shaft has just been released from the recess in the second shaft, and then being closed again, so that compressed air is temporarily supplied to the first portion,
the outlet opening is permanently open, so that the air is continuously output via the outlet opening.

This design corresponds in essence to the motor portion of an Astron motor. A compressed-air motor of this kind is designed, in principle, inversely to the compressor part of an Astron motor.

However, it is particularly advantageous when the compressed-air motor is designed as a screw motor. Screw motors are generally known to those skilled in the art. Purely by way of example, reference may be made to the doctoral thesis “Grundlagen der Zweiphasen-Schraubenmotors [Fundamentals of the Two-Phase Screw Motor]” by Bernhard Paul Kliem, Faculty of Mechanical Engineering, University of Dortmund (Germany). In principle, a screw motor is constructed inversely to a screw compressor. A screw motor typically has two oppositely rotating shafts which enclose air in a chamber between them. The chamber moves in the axial direction when the two shafts rotate, with the chamber volume increasing.

In a particularly preferred configuration of the system, the system has an electric machine which for its part has a housing in which a first and a second shaft are mounted coaxially in relation to each other. In this configuration, the first and the second shaft each support an active part of the electric machine, so that an electromotive force can act between the two active parts. In this configuration, the first shaft is connected to the compressed-air motor and the second shaft is connected to the compressors of the compressor arrangement. The electric machine therefore acts as an electric difference machine.

This configuration has the particular advantage that—instead of an electrical generator connected to the compressed-air motor and (at least) one electric motor connected to the compressors—only one single electric machine is required, which furthermore can be designed to be smaller than would be required in the case of the two individual electric machines (generator and motor).

The last-mentioned configuration can be yet further improved by way of the system having a further electric machine, the stator of which is arranged in a rotationally fixed manner and the rotor of which is connected to the compressed-air motor or the compressors of the compressor arrangement. As a result, the operation of the compressed-air motor and the operation of the compressor arrangement can be decoupled from each other within the power limits of the further electric machine. The further electric machine can often be dimensioned to be considerably smaller than the first-mentioned electric machine, for example by an order of magnitude (=factor of 10).

In a further preferred configuration, the system has at least one tapping point at which air can be extracted from the compressor arrangement, wherein the air extracted from the compressor arrangement has an extraction pressure, which is greater than the initial pressure and is at most as high as the final pressure. As a result, independent generation of compressed air for the main plant is not required. It may also be possible for an existing compressed-air system of the main plant to be redesigned and retrofitted such that it forms a system according to the invention.

### BRIEF DESCRIPTION OF THE DRAWINGS

The properties, features and advantages of this invention described above and the way in which they are achieved will become clearer and more easily understandable in conjunction with the following description of an exemplary embodiment, which will be explained in more detail in conjunction with the drawings, in which:

FIG. 1 shows a main plant and a recovery device,

FIG. 2 shows a structural design of a recovery device,

FIG. 3 shows a main plant and a heat exchanger,

FIG. 4 shows a structure for heat transmission,

FIG. 5 shows a control structure,

FIG. 6 shows a compressor arrangement, a compressed-air motor and an electric machine,

FIG. 7 shows a modification of FIG. 6, and

FIG. 8 shows a further modification of FIG. 6.

### DESCRIPTION OF THE EMBODIMENTS

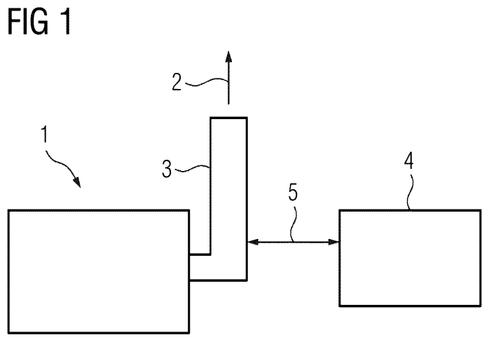

According to FIG. 1, a system for recovering energy has a main plant 1. A hot waste gas 2 is produced during operation of the main plant 1. The hot waste gas 2 flows through a discharge device 3 of the main plant 1 and is thus discharged from the main plant 1. The main plant 1 is often a plant used in the steel industry, for example a slab reheating furnace or an electric steelworks. However, the present invention is not restricted to plants used in the steel industry.

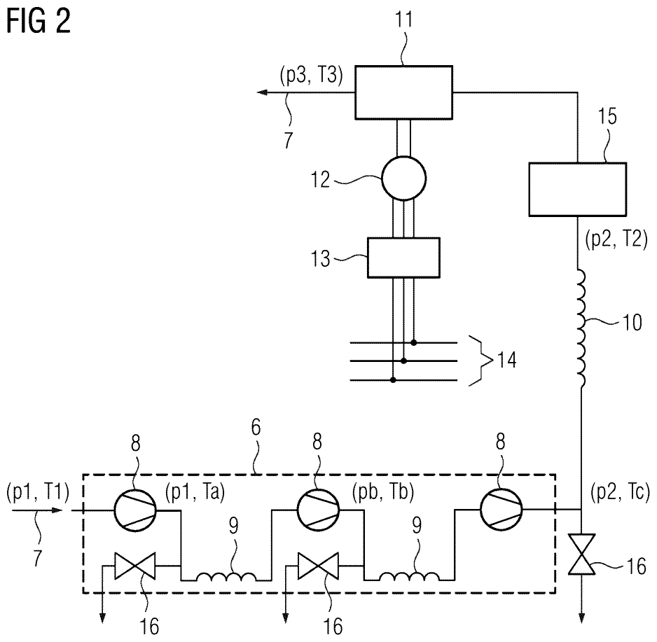

The system also has further plant components, by means of which the thermal energy of the hot waste gas 2, that is to say the waste heat from the main plant 1, is intended to be utilized for generating initially mechanical energy and, generally on the basis of this, electrical energy. The further plant components in their entirety are referred to as recovery device 4 below. The recovery device 4 is thermally coupled to the hot waste gas 2, which flows through the discharge device 3. The thermal coupling is indicated by a double-headed arrow 5 in FIG. 1. The structural design of the recovery device 4 is explained in conjunction with FIG. 2.

According to FIG. 2, the recovery device 4 has a compressor arrangement 6. Air 7, which is supplied to the compressor arrangement 6 at an initial temperature T1 and an initial pressure p1, is compressed to a final pressure p2 and an intermediate temperature Tc by means of the compressor arrangement 6. For this purpose, the compressor arrangement 6 has a number of compressors 8.

The number of compressors 8 can be as required. In many cases, the number of compressors 8 is greater than 1. In this case, the compressors 8 are arranged one behind the other in series. The number of three compressors 8 shown in FIG. 2 is merely exemplary. On account of the arrangement of the compressors 8 in series, the air 7 is compressed to the final pressure p2 by means of the compressors 8, starting from the initial pressure p1, in several stages. According to the exemplary embodiment, the frontmost compressor 8 compresses the air 7 to the intermediate pressure pa starting from the initial pressure p1. At the output end of this compressor 8, the air 7 has the temperature Ta. The temperature Ta is greater than the initial temperature T1. Analogously, the central compressor 8 compresses the air 7 to the intermediate pressure pb, starting from the intermediate pressure pa. At the output end of this compressor 8, the air 7 has the temperature Tb. Analogously, the last compressor 8 compresses the air 7 to the final pressure p2, starting from the intermediate pressure pb. At the output end of this compressor 8, the air 7 has the intermediate temperature Tc. Therefore, several pressures pa, pb are produced within the chain of compressors 8.

In the case of several compressors 8, the system preferably also has, in accordance with the illustration in FIG. 2, cooling devices 9, which are arranged between in each case two successive compressors 8. The cooling devices 9 are used to cool the air 7 which is conveyed from the compressor 8 arranged upstream of the respective cooling device 9 to the compressor 8 arranged downstream of the respective cooling device 9. If possible, the air is cooled down to the initial temperature T1 in each case. Virtually any desired cooling medium can be used in order to cool the air 7, for example cooling water, which is used for cooling a rolled material after it has passed through a rolling line. However, the air 7 is cooled only between the individual compressors 8. There is no cooling device arranged downstream of the compressor 8 by which the air 7 is compressed to the final pressure p2 and the intermediate temperature Tc. This applies irrespective of whether there are several compressors 8 arranged in series, in accordance with the illustration in FIG. 2, or whether there is only one single compressor 8.

The system also has a heat exchanger 10. The heat exchanger 10 is arranged downstream of the compressor arrangement 6. The air 7, which already has the final pressure P2 but still has the intermediate temperature Tc, flows through the heat exchanger 10. The heat of the waste gas 2, which flows through the discharge device 3, is supplied to the air 7 flowing through the heat exchanger 10 by means of the heat exchanger 10. As a result, the air 7 is heated to a final temperature T2.

Finally, the system has a compressed-air motor 11. The compressed-air motor 11 is arranged downstream of the heat exchanger 10. The air 7, which is heated to the final temperature T2 at this time and still has the final pressure p2, is supplied to the compressed-air motor 11. Therefore, the compressed-air motor 11 is operated with this air 7. The air 7 at an outlet temperature T3 and an output pressure p3 is output by the compressed-air motor 11.

Mechanical energy is initially generated by means of the compressed-air motor 11. In many cases however, the compressed-air motor 11 is coupled to an electric machine 12, which is operated in generator mode as a result. The electrical energy generated by the electric machine 12 can therefore be fed to an electrical system 14—for example via a converter 13.

FIG. 2 shows not only the minimal configuration of the recovery device 4 explained above, but also a few configurations as well. These configurations can be implemented independently of each other.

One configuration is that the system has a compressed-air reservoir 15. The compressed-air reservoir 15 is arranged between the heat exchanger 10 and the compressed-air motor 11. The air 7 heated to the final temperature T2 and having the final pressure p2 is supplied to the compressed-air reservoir 15. The air 7 heated to the final temperature T2 and having the final pressure P2 is supplied from the compressed-air reservoir 15 to the compressed-air motor 11.

A further configuration is that the air 7 supplied to the compressor arrangement 6 is extracted from the surrounding area.

The air 7 supplied to the compressor arrangement 6 therefore has the normal atmospheric pressure of approximately 100,000 Pa as the initial pressure p1 and a locally customary temperature, which can vary for example between −20° C. and +40° C. depending on the time of day and the time of year, as the initial temperature T1 before compression in the compressor arrangement 6.

A further configuration is that the air 7 output by the compressed-air motor 11 is output to the surrounding area.

A further configuration is that the system has at least one tapping point 16. Air 7 can be extracted from the compressor arrangement 6 at the tapping points 16. The tapping points 16 can be designed, for example, as valves. The extracted air 7 has an extraction pressure, which is greater than the initial pressure p1 and at most as high as the final pressure p2. In accordance with the illustration in FIG. 2, for example air 7 at an intermediate pressure pa, air 7 at the intermediate pressure pb and air 7 at the final pressure p2 can be extracted from the compressor arrangement 6.

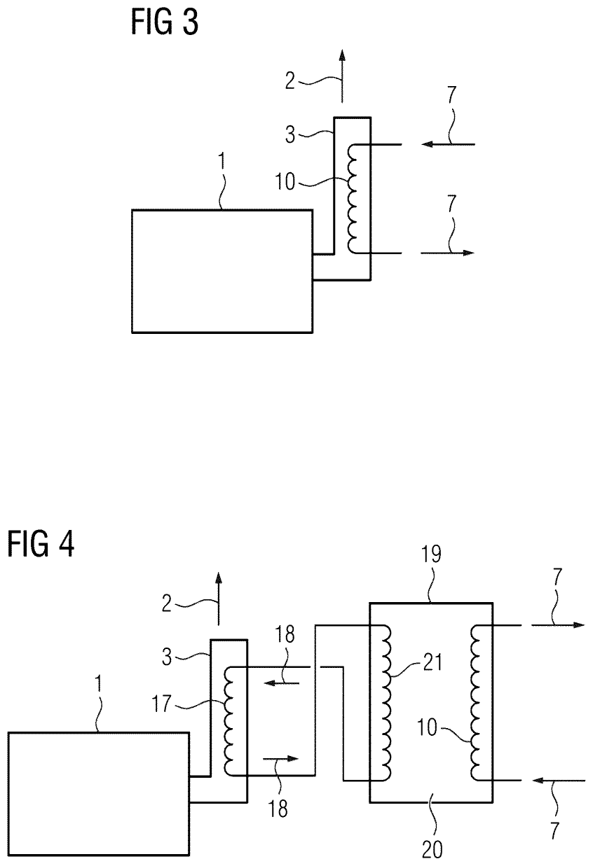

Various configurations are possible for supplying the heat of the waste gas 2 to the air 7. The simplest configuration is that, in accordance with the illustration in FIG. 3, the heat exchanger 10 is arranged in the discharge device 3, so that the waste gas 2 flows directly around the heat exchanger 10 and therefore the heat of the waste gas 2 is transmitted directly to the heat exchanger 10.

As an alternative, in accordance with the illustration in FIG. 4, it is possible for the system to have a further heat exchanger 17, which is arranged in the discharge device 3 and around which the waste gas 2 flows. In this case, the heat of the waste gas 2 is initially transmitted to an intermediate medium 18 which flows through the further heat exchanger 17. In this case, the intermediate medium 18 acts on the heat exchanger 10, that is to say that heat exchanger through which the air 7 flows and by means of which the air 7 is heated. The effect can be direct. This is not shown in FIG. 4. What is shown however is an advantageous configuration in which the intermediate medium 18 acts indirectly on the heat exchanger 10 heating the air 7. The intermediate medium 18 may be a thermal oil, for example.

In this advantageous configuration, the system has a heat store 19. A suitable storage medium 20 is located in the heat store 19. In this case, the heat exchanger 10 is arranged at least in the upper region of the heat store 19. It is even better when the heat exchanger 10 extends in the vertical direction over a considerable portion of the height of the heat store 19. In this case, the air 7 flows through the heat exchanger 10 and thus the heat exchanger 19 from bottom to top. Furthermore, a heat output device 21 is arranged at least in the lower region of the heat exchanger 19. The intermediate medium 18 introduces the heat into the heat store 19 or into the storage medium 20 by means of the heat output device 21. It is even better when the heat output device 21 extends in the vertical direction over a considerable portion of the height of the heat store 19. In this case, the intermediate medium 18 flows through the heat output device 21 and thus the heat exchanger 19 from top to bottom. The storage medium 20 may also be a thermal oil.

The heat output device 21 is shown as a (further) heat exchanger in FIG. 4, so that the intermediate medium 18 is separated from the storage medium 20. Provided that the intermediate medium 18 and the storage medium 20 are identical, the heat output device 21 can however also be designed as a simple pipe which issues into the heat store 19. In this case, a further pipe—of course—also leads from the heat store 19 back to the heat exchanger 17 again.

The air 7 heats up during the compression processes in the compressors 8 of the compressor arrangement 6. This is unavoidable. In order to minimize the mechanical energy required for compressing the air 7 (and therefore generally also electrical energy), the air 7 is however compressed preferably in stages in accordance with the illustration in FIG. 2, the air 7 being cooled between the individual compression processes time and again. Furthermore, the air 7 in the compressed-air motor 11 expands and cools down in the process. This is unavoidable too. Furthermore, adiabatic expansion of the air 7 generally takes place in the compressed-air motor 11. If V2 denotes the volume of air 7 which is supplied to the compressed-air motor 11 for a single working cycle at the final pressure p2, and V3 denotes the volume of air 7 which is output by the compressed-air motor 11 after this working cycle, that is to say after the expansion, the following equation holds true in very good approximation

$${( V 2 / V 3 )}^{1.4} {( T 3 / T 2 )}^{3.5} = p 3 / p 2 \qquad ( 1 )$$

The air 7 is generally output from the compressed-air motor 11 to a reservoir (this may also be the normal surrounding area) in which the initial temperature T1 and the initial pressure p1 prevail. Therefore, in the ideal case, the equation

$${( V 2 / V 3 )}^{1.4} {( T 1 / T 2 )}^{3.5} = p 1 / p 2 \qquad ( 2 )$$

should be satisfied. In other words: in the ideal case, the output temperature T3 and the output pressure p3 correspond at least approximately to the initial pressure p1 and the initial temperature T1:

$$p 3 = p 1 and T 3 = T 1 \qquad ( 3 )$$

In the ideal case, the manner of operation of the compressor arrangement 6 and the manner of operation of the compressed-air motor 11 are therefore matched to one another in such a way that the air 7 is returned precisely to the pressure and the temperature with which the circuit is closed, that is to say to the initial pressure p1 and the initial temperature T1, at the time at which it exits from the compressed-air motor 11. The time mentioned above is the time at which the transition from expansion of the air 7 located in the compressed-air motor 11 to output of the air 7 located in the compressed-air motor 11 is made.

In accordance with the illustration in FIG. 5, the system preferably has a control device 22, by means of which the compressor arrangement 6 and/or the compressed-air motor 11 are controlled in such a way that this condition—to the extent possible—is satisfied, that is to say that the output temperature T3 and the output pressure p3 at least approximately correspond to the initial pressure p1 and the initial temperature T1. The efficiency can be optimized in this way.

According to FIG. 5, the initial temperature T1 and the final temperature T2 and the initial pressure p1 are supplied to the control device 22 as input variables. This is because these variables have to be accepted as they are.

The control device 22 controls—as far as possible—initially the ratio of the volumes V2 and V3, so that the ratio satisfies a predetermined condition that is dependent on the ratio of the temperatures T1 and T2, for example the condition according to the above equation. Although the volumes V2 and V3 of a compressed-air motor 11 once established can now longer be varied, t is possible to arrange, for example, several compressed-air motors 11, in which the ratios of the volumes V2 and V3 differ from each other, in parallel and to define which of the compressed-air motors 11 is active by means of actuating upstream valves. Analogously, it may also be possible to arrange several compressed-air motors 11 one behind the other in series and to provide the possibility of decoupling (bypassing) one or more of the compressed-air motors 11 from the series in order to optimize the (resulting) ratio of the volumes V2 and V3.

Varying the ratio of the volumes V2 and V3 in this way is also of considerable importance for optimum operation. If—for example—the final temperature T2 is 300° C. or 573 K and the initial temperature T1 (i.e. the ambient temperature) can fluctuate between −20° C. and +40° C., the optimum ratio of the volumes V2 and V3 lies between 7.72 and 4.535. In such a case, a dedicated compressed-air motor 11 can be provided for example for each of four temperature ranges of 15 K in each case, it being possible for the volume ratios of the compressed-air motors 11 to be (approximately) 4.83, 5.47, 6.25 and 7.19. The temperature range is then used to select which of the compressed-air motors 11 will be actively operated.

Furthermore, the control device 22—possibly after defining the configuration in which the compressed-air motor 11 is operated—controls the compressor arrangement 6 and/or the compressed-air motor 11 in such a way that the final pressure p2 satisfies a predetermined condition that is dependent on the ratio of the temperatures T1 and T2, for example the condition according to the above equation. For example, the volume flow supplied to the compressor arrangement 6 and the volume flow output by the compressed-air motor 11 can be matched to one another by adapting a rotation speed nK of the compressor arrangement 6 and/or rotation speed nM of the compressed-air motor 11 to each other—based on the initial pressure p1—so that the desired final pressure p2 is set.

Taking the same final temperature T2 (300° C.) and the possible initial temperature T1 as a basis, the optimal ratio of final pressure p2 to initial pressure p1 lies between around 17.5 and around 8.3. Since the initial pressure p1 (i.e. the atmospheric pressure in the surrounding area) can furthermore also fluctuate to some extent, the final pressure p2 should be varied to a yet somewhat greater extent, for example in the event of a fluctuation in the initial pressure p1 by up to 4% upward and downward between 800,000 Pa and 1, 820,000 Pa. The ratio between the maximum possible final pressure p2 and the minimum possible final pressure p2 therefore lies at somewhat above 2.25. As an alternative, it would also be possible to always generate a relatively high final pressure p2 of, for example, 1,820,000 Pa but not to feed the air 7 to the surrounding area, but rather to a location within the compressor arrangement 6, for example between the first and the central compressors 8 of the compressor arrangement 6 of FIG. 2, at the output end of the compressed-air motor 11.

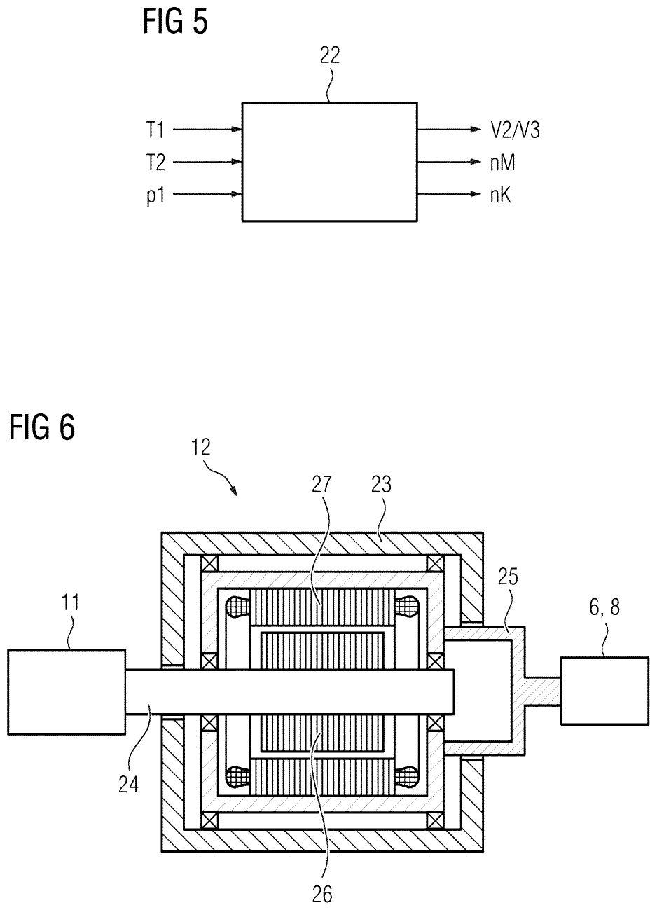

As already mentioned and also shown in FIG. 6, the compressed-air motor 11 is usually coupled to an electric machine 12, so that the compressed-air motor 11 drives the electric machine 12 in order to generate electrical energy. Furthermore, electric drives are also required for driving the compressors 8. According to the illustration in 6, figure this can advantageously be achieved by way of the electric machine 12 having a housing 23 in which a first shaft 24 and a second shaft 25 are mounted coaxially in relation to each other. The illustration in FIG. 6, according to which the second shaft 25 is supported on the first shaft 24 and is therefore indirectly mounted in the housing 23, is merely purely exemplary.

The first shaft 24 and the second shaft 25 each support an active part 26, 27 of the electric machine 12. An electromotive force can act between the two active parts 26, 27. The two active parts 26, 27 therefore correspond from the start to the rotor and to the stator of the electric machine 12. However, on account of the arrangement of the two active parts 26, 27 on the shafts 24, 25, not only can the “rotor” rotate about its axis, but the “stator” can too. This configuration can advantageously be used by way of the first shaft 24 being connected to the compressed-air motor 11 and the second shaft 25 being connected to the compressors 8 of the compressor arrangement 6. As a result, the compressed-air motor 11 directly drives the compressors 8 of the compressor arrangement 6. Therefore, conversion of the mechanical energy provided by the compressed-air motor 11 into electrical energy and further conversion of the electrical energy into mechanical energy for driving the compressors 8 are therefore dispensed with. The losses associated with each conversion can therefore be avoided too. As a result, the remaining portion of mechanical energy, which can be converted into electrical energy by the electric machine 12, can be increased.

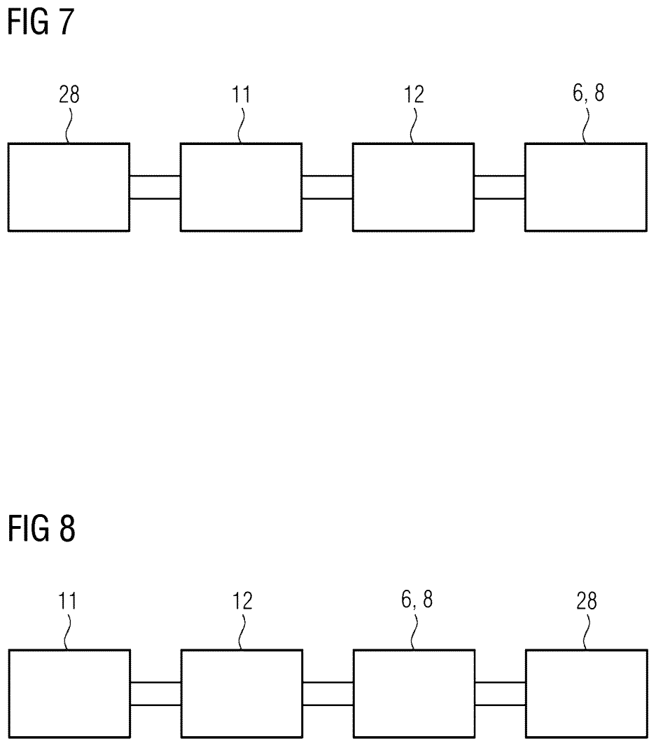

If the arrangement, as illustrated in FIG. 6, were not to have any further electric machine, decoupled operation of the compressor arrangement 6 and of the compressed-air motor 11 would not be possible. In order to be able to achieve such decoupled operation, the system therefore has a further electric machine 28 according to the illustrations in FIGS. 7 and 8. In this electric machine 28, the stator is arranged in a rotationally fixed manner, as is generally usual. The rotor of the further electric machine 28 can be connected to the compressed-air motor 11 (FIG. 7) or to the compressors 8 of the compressor arrangement 6 (FIG. 8) as required.

The compressors 8 of the compressor arrangement 6 can be designed as required. It is possible for the compressors 8 to be designed as gas turbines. It is usually better when the compressors 8 are designed as compressor parts of Astron motors. The design of compressor parts of this kind is explained in detail in the introductory part of the description. It is usually even better when the compressors 8 are designed as screw compressors. Screw compressors in achieve very particular high relative efficiencies of far greater than 908. The relative efficiency is defined as the quotient between the actual efficiency and the theoretically possible efficiency. If—for example—at given temperature ratios, a calculation according to the Carnot cycle results in an efficiency of 32% and the actual machine has an efficiency of 24%, the relative efficiency is 24%/32%=75%.

Analogously to the compressors 8, the compressed-air motor 11 can also be designed as required. For example, the compressed-air motor 11 can be designed as a gas turbine. It is usually better when the compressed-air motor 11 is designed as a motor component of an Astron motor. The design of a motor component of this kind is explained in detail in the introductory part of the description. It is usually even better when the compressed-air motor 11 is designed as a screw motor. Screw motors in particular achieve very high relative efficiencies of far greater than 90%. The relative efficiency is defined in the same way as was explained above for compressors 8.

A high relative efficiency of the compressed-air motor 11 and the compressors 8 is also of great importance for economical operation of the system. This is because the absolute efficiency of the Carnot cycle is somewhat above 30% at customary initial and final temperatures T1, T2. Each percent of relative efficiency that is lost during operation of the compressors 8 and during operation of the compressed-air motor 11 reduces the relative efficiency of the overall system by approximately 4% at customary temperature ratios. If—for example—under ideal, fully loss-free conditions, a thermal power of 3.84 MW is available and the compressed-air motor 11 delivers a power of 2.83 MW and furthermore the compressors 8 require a power of 1.66 MW, the system can deliver as useful power

$$2.83 MW - 1.66 MW = 1.17 MW . \qquad ( 4 )$$

In practice however, losses always occur. For example, on the part of the compressed-air motor 11, frictional losses occur in the compressed-air motor 11 and the electric machine 12, electrical losses occur in the electric machine 12 and converter losses occur in the converter 13. Analogously, frictional losses occur in the compressors 8 and the driving electric motors and electrical losses occur in the driving electric motors and the associated feeding converters for driving the compressors 8. It is assumed below that the relative efficiency of the total respective chain is 95% in both cases, this being a very good value in practice. Even at such a still high relative efficiency, the useful power has already decreased to

$$0.95 \cdot 2.83 MW - 1.66 MW / 0.95 = 0.94 MW . \qquad ( 5 )$$

The useful power therefore decreases to approximately 80% of its theoretically possible maximum. At a relative efficiency of 90%, the useful power decreases to approximately 60% of its theoretically possible maximum, at a relative efficiency of 85% to approximately 38.5%, and at 80% to only just 16%. At a relative efficiency of approximately 76.58, the useful power drops to 0 and becomes negative thereafter. A high relative degree of utilization is therefore of great importance.

The present invention has many advantages. Initially, the waste heat from the main plant 1 can be used efficiently. Owing to the use of air 7 as working medium, no special precautions to prevent the air 7 escaping are further required either. This is because although air escaping in this way may lead to a reduction in the efficiency it does not have an environmental impact. The compressors 8 and the compressed-air motor 11 can be of simple and robust construction. Given an appropriate design, they can operate with a high relative efficiency (considerably greater than 90%).

Although the invention has been illustrated and described in detail by the preferred exemplary embodiments, the invention is not restricted by the examples disclosed and other variations can be derived from them by a person skilled in the art, without departing from the scope of protection of the invention as defined by the claims.

### LIST OF REFERENCE SIGNS

1 main plant
2 waste gas
3 discharge device
4 recovery device
5 double-headed arrow
6 compressor arrangement
7 air
8 compressors
9 cooling devices
10, 17 heat exchanger
11 compressed-air motor
12, 28 electric machines
13 converter
14 electrical system
15 compressed-air reservoir
16 tapping points
18 intermediate medium
19 heat store
20 storage medium
21 heat output device
22 control device
23 housing
24, 25 shafts
26, 27 active parts
nK, nM rotation speeds
p1, p2, p3, pa, pb pressures
T1, T2, T3, Ta, Tb, Tc temperatures
V2, V3 volumes

1. A system for recovering energy,
wherein the system has a main plant, during the operation of which a hot waste gas is produced,
wherein the main plant has a discharge device, through which the waste gas flows and via which the waste gas is discharged from the main plant,
wherein the system has a compressor arrangement having a number of compressors, by means of which air supplied to the compressor arrangement) and having an initial temperature is compressed from an initial pressure to a final pressure and an intermediate temperature,
wherein the system has a heat exchanger arranged downstream of the compressor arrangement, through which the air compressed to the final pressure and the intermediate temperature flows and by means of which the heat of the waste gas flowing through the discharge device is supplied to the air flowing through the heat exchanger and thus the air is heated to a final temperature, and
wherein the system has a compressed-air motor which is arranged downstream of the heat exchanger, to which the air heated to the final temperature and having the final pressure is supplied, which is operated with this air and from which the air is output at an output temperature and an output pressure.

2. The system as claimed in claim 1, wherein
the number of compressors is greater than 1 and the compressors are arranged one behind the other in series, so that the air, starting from the initial pressure, is compressed to the final pressure in several stages, and in that the system has cooling devices which are arranged between two successive compressors in each case and by means of which the air conveyed from the compressor arranged upstream of the respective cooling device to the compressor arranged downstream of the respective cooling device is cooled.

3. The system as claimed in claim 1, wherein
the system has no cooling device downstream of the compressor by which the air is compressed to the final pressure and the intermediate temperature.

4. The system as claimed in claim 1, wherein
the system has a further heat exchanger, which is arranged in the discharge device and by means of which the heat of the waste gas is transmitted to an intermediate medium, and in that the intermediate medium acts directly or indirectly on the heat exchanger heating the air.

5. The system as claimed in claim 4, wherein
the system has a heat store, in that the heat exchanger is arranged at least in the upper region of the heat store and preferably the air flowing through the heat exchanger flows through the heat store from bottom to top, and in that a heat output device is arranged at least in the lower region of the heat store and preferably the intermediate medium flows through the heat store from top to bottom, so that the intermediate medium introduces heat into the heat store via the heat output device.

6. The system as claimed in claim 1, wherein
the heat exchanger is arranged in the discharge device, so that the heat of the waste gas is transmitted directly to the heat exchanger.

7. The system as claimed in claim 1, wherein
the system has a compressed-air reservoir, which is arranged between the heat exchanger and the compressed-air motor.

8. The system as claimed in claim 1, wherein the air supplied to the compressor arrangement is extracted from the surrounding area.

9. The system as claimed in claim 1, wherein
the air output by the compressed-air motor is output to the surrounding area.

10. The system as claimed in claim 1, wherein
the system has a control device, by means of which the compressor arrangement and/or the compressed-air motor are controlled in such a way that the output temperature and the output pressure at least approximately correspond to the initial pressure and the initial temperature.

11. The system as claimed in claim 1, wherein
the compressor arrangement has gas turbines or screw compressors as compressors, or in that the compressors are each designed as follows:
the compressors have a first and a second shaft, the shaft axes of which are arranged parallel to each other with a lateral offset and which rotate synchronously and at the same rotation speed during operation, so that the two shafts roll on each other and are sealed off from each other in an airtight manner,
the compressors have a housing, which annularly surrounds the first shaft,
the first shaft has, on its outer side, a lug which encircles the housing in a sealing manner,
the second shaft has, on its outer side, a recess which the lug of the first shaft temporarily enters when the shafts rotate and from which the lug of the first shaft is later released again, *
a supply opening and an outlet opening are arranged in the housing, the supply opening and the outlet opening being passed by the lug, as seen in the rotation direction of the first shaft, shortly after it is released from the recess or shortly before it enters the recess, so that the lug divides a respective cavity formed by the first shaft and the surrounding housing into a first and a second portion, wherein the first portion extends from the angular position at which the lug of the first shaft is released from the recess in the second shaft up to the instantaneous angular position of the lug and the second portion extends from the instantaneous position of the lug up to the angular position at which the lug of the first shaft enters the recess in the second shaft,
the inlet opening is permanently open, so that air is continuously supplied to the first portion,
the compressed air is output via the outlet opening,
a closing apparatus is assigned to the outlet opening, the outlet opening being briefly opened by the closing apparatus during a period in which the lug of the first shaft is just about to enter the recess in the second shaft, and then being closed again.

12. The system as claimed in claim 1, wherein
the compressed-air motor is designed as a gas turbine or as a screw motor or is designed as follows:
the compressed-air motor has a first and a second shaft, the shaft axes of which are arranged parallel to each other with a lateral offset and which rotate synchronously and at the same rotation speed during operation, so that the two shafts roll on each other and are sealed off from each other in an airtight manner,
the compressed-air motor has a housing, which annularly surrounds the first shaft,
the first shaft has, on its outer side, a lug which encircles the housing in a sealing manner,
the second shaft has, on its outer side, a recess which the lug of the first shaft temporarily enters when the shafts rotate and from which the lug of the first shaft is later released again,
a supply opening and an outlet opening are arranged in the housing, the supply opening and the outlet opening being passed by the lug, as seen in the rotation direction of the first shaft, shortly after it is released from the recess or shortly before it enters the recess, so that the lug divides an annular cavity formed by the first shaft and the surrounding housing into a first and a second portion, wherein the first portion extends from the angular position at which the lug of the first shaft is released from the recess in the second shaft up to the instantaneous angular position of the lug and the second portion extends from the instantaneous position of the lug up to the angular position at which the lug of the first shaft enters the recess in the second shaft,
a closing apparatus is assigned to the supply opening, the supply opening being briefly opened by the closing apparatus during a period in which the lug of the first shaft has just been released from the recess in the second shaft, and then being closed again, so that compressed air is temporarily supplied to the first portion,
the outlet opening is permanently open, so that the air is continuously output via the outlet opening.

13. The system as claimed in claim 1, wherein
the system has an electric machine, in that the electric machine has a housing in which a first and a second shaft are mounted coaxially in relation to each other, in that the first and the second shaft each support an active part of the electric machine, so that an electromotive force can act between the two active parts, in that the first shaft is connected to the compressed-air motor, and in that the second shaft is connected to the compressors of the compressor arrangement.

14. The system as claimed in claim 13, wherein
the system has a further electric machine, the stator of which is arranged in a rotationally fixed manner and the rotor of which is connected to the compressed-air motor or the compressors of the compressor arrangement.

15. The system as claimed in claim 1, wherein
the system has at least one tapping point at which air can be extracted from the compressor arrangement, wherein the air extracted from the compressor arrangement has an extraction pressure, which is greater than the initial pressure and is at most as high as the final pressure.
